(19) United States
(12) Patent Application Publication
(10) Pub. No.: US 2022/0237362 A1
(43) Pub. Date: Jul. 28, 2022

(54) INFORMATION DISPLAY METHOD, DEVICE, APPARATUS, MEDIUM, AND PROGRAM PRODUCT FOR PAGE ELEMENT

(71) Applicant: Beijing Zhuoyue Lexiang Network Technology Co., Ltd., Beijing (CN)

(72) Inventor: Dan ZHANG, Beijing (CN)

(21) Appl. No.: 17/582,883

(22) Filed: Jan. 24, 2022

(30) Foreign Application Priority Data
Jan. 25, 2021 (CN) 202110099399.3
Jan. 19, 2022 (CN) 202210061692.5

(51) Int. Cl. G06F 40/106; G06F 3/04842; G06F 40/117; G06F 40/205; G06F 9/451

(52) U.S. Cl. CPC G06F 40/106; G06F 3/04842; G06F 9/451; G06F 40/205; G06F 40/117

(57) ABSTRACT

A method and device for information display of interface elements, an apparatus, a medium, and a program product are provided. The method comprises: in response to an element selection operation applied to a User Interface (UI), determining identification information of a target element corresponding to the element selection operation based on an operation position of the element selection operation on the UI and a correspondence between the position on the UI and the identification information of the element; acquiring a layout file corresponding to the target element based on the identification information of the target element; and displaying the layout file corresponding to the target element.

### TECHNICAL FIELD

The present disclosure relates to the technical field of a computer, and particularly to an information display method and device of an interface element, an apparatus, a medium, and a program product.

### BACKGROUND

With the development of Internet technology, complexity of a User Interface (UI) is getting higher and higher. Accordingly, the layout information that a single UI needs to carry is becoming more and more, and the code logic of the single UI is also becoming more and more complex. Improving the convenience of information display of an interface element is of great significance in the development of the UI.

### SUMMARY

The present disclosure provides a technical solution of information display of interface elements.

In an aspect of the present disclosure, there is provided a method for information display of interface elements, comprising: in response to an element selection operation applied to a user interface determining identification information of a target element corresponding to the element selection operation based on an operation position of the element selection operation on the user interface and a correspondence between the position on the user interface and identification information of the element; acquiring a layout file corresponding to the target element based on the identification information of the target element; and displaying the layout file corresponding to the target element.

In response to an element selection operation applied to a user interface, identification information of a target element corresponding to the element selection operation is determined based on an operation position of the element selection operation on the user interface and a correspondence between the position on the UI and identification information of the element, a layout file corresponding to the target element is acquired based on the identification information of the target element, and the layout file corresponding to the target element is displayed, and thus, the target element can be automatically determined based on the operation position of the element selection operation of a user in the UI without manually comparing coordinates to determine the target element by the user, and the layout files corresponding to the elements in the UI can be rapidly acquired and displayed, so that a developer of the UI can rapidly view the layout file corresponding to the target element in the process of viewing the UI by selecting the target element in the UI. Therefore, the problems of high operation complexity and long time consumption of searching for layout files corresponding to the elements in the UI in the related art can be solved, and the efficiency of developing the UI by the developer of the UI can be improved.

In a possible implementation, said acquiring the layout file corresponding to the target element based on the identification information of the target element comprises: acquiring tag information of the target element based on the identification information of the target element; and acquiring the layout file corresponding to the target element from the tag information of the target element.

In this implementation, tag information of the target element is acquired based on the identification information of the target element, and the layout file corresponding to the target element is acquired from the tag information of the target element, and thus, convenience in acquisition of the layout file corresponding to the target element can be improved.

In a possible implementation, before determining the identification information of the target element corresponding to the element selection operation based on the operation position of the element selection operation on the user interface and the correspondence between the position on the user interface and the identification information of the element in response to the element selection operation applied to the user interface, the method further comprises: in response to an activation of the user interface, acquiring structural information of the user interface; and parsing the structural information to obtain the correspondence between the position on the user interface and the identification information of the element.

In this implementation, in response to an activation of the UI, structural information of the UI is acquired, the structural information is parsed, and the correspondence between the position on the UI and the identification information of the element is obtained, and thus, after the element selection operation applied to the UI is detected, the target element can be automatically, accurately and rapidly determined based on the operation position of the element selection operation on the UI and the correspondence.

In a possible implementation, before acquiring the layout file corresponding to the target element based on the identification information of the target element, the method further comprises: in response to an activation of the user interface, acquiring a layout file corresponding to the user interface; and parsing the layout file corresponding to the user interface to obtain a layout file corresponding to the element in the user interface.

In this implementation, in response to an activation of the UI, a layout file corresponding to the UI is acquired, the layout file corresponding to the UI is parsed, and layout files corresponding to the elements in the UI are obtained, and thus, the layout file corresponding to each element in the UI can be timely obtained, so that after the element selection operation applied to the UI is detected, the layout file of the corresponding element can be timely displayed to the user, and the fluency of displaying the layout file corresponding to the element can be improved.

In a possible implementation, after obtaining the layout file corresponding to the element in the user interface, the method further comprises: for an arbitrary element of the user interface, setting tag information of the element, and storing the layout file corresponding to the element through the tag information of the element.

In this example, by setting the tag information of an element, and storing the layout file corresponding to the element through the tag information of the element, the layout file corresponding to the element can be rapidly acquired from the tag information of the element when the layout file corresponding to the element needs to be displayed.

In a possible implementation, acquiring the layout file corresponding to the target element based on the identification information of the target element comprises: in response to that the operation position corresponds to two or more target elements, acquiring the layout files corresponding to the two or more target elements based on the identification information of the two or more target elements; and displaying the layout file corresponding to the target element comprises: displaying the layout files corresponding to the two or more target elements based on hierarchy information and/or position information of the two or more target elements.

In this implementation, in a case that the operation position corresponds to two or more target elements, layout files corresponding to the two or more target elements are acquired based on identification information of the two or more target elements, and the layout files corresponding to the two or more target elements are displayed based on hierarchy information and/or position information of the two or more target elements; and thus, in a case that the elements in the UI overlap or are close to each other, the layout files corresponding to the target elements also can be orderly displayed, which facilitates to reduce the probability of the developer mis-reading or mis-modifying the layout files.

In a possible implementation, after displaying the layout file corresponding to the target element, the method further comprises: in response to a modification instruction for the layout file corresponding to the target element, modifying the layout file corresponding to the target element.

In this implementation, the layout file corresponding to the target element can be rapidly acquired and displayed, and the user is allowed to modify the displayed layout file; and thus, the time for modifying layout information of the elements by the developer of the UI can be shortened, so that the speed of modifying the elements in the UI can be increased, and the developing efficiency can be improved.

In an aspect of the present disclosure, there is provided a device for information display of interface elements, comprising a determination module to determine, in response to an element selection operation applied to a user interface, identification information of a target element corresponding to the element selection operation based on an operation position of the element selection operation on the user interface and a correspondence between the position on the user interface and identification information of element; a first acquisition module to acquire a layout file corresponding to the target element based on the identification information of the target element; and a display module to display the layout file corresponding to the target element.

In a possible implementation, the first acquisition module is used for: acquiring tag information of the target element based on the identification information of the target element; and acquiring a layout file corresponding to the target element from the tag information of the target element.

In a possible implementation, the device further comprises: a second acquisition module to acquire, in response to an activation of the user interface, structural information of the user interface; and a first parsing module to parse the structural information to obtain a correspondence between the position on the user interface and the identification information of the element.

In a possible implementation, the device further comprises: a second parsing module to acquire, in response to an activation of the user interface, a layout file corresponding to the user interface; and a third acquisition module to parse the layout file corresponding to the user interface to obtain a layout file corresponding to the element in the UI.

In a possible implementation, the device further comprises: a setting module to set, for an arbitrary element of the user interface, the tag information of the element, and store the layout file corresponding to the element through the tag information of the element.

In a possible implementation, the first acquisition module is configured to acquire, in response to that the operation position corresponds to two or more target elements, the layout files corresponding to the two or more target elements based on the identification information of the two or more target elements; and the display module is configured to display the layout files corresponding to the two or more target elements based on hierarchy information and/or position information of the two or more target elements.

In a possible implementation, the device further comprises: a modification module to modify, in response to a modification instruction for the layout file corresponding to the target element, the layout file corresponding to the target element.

In an aspect of the present disclosure, there is provided an electronic apparatus comprising: one or more processors; and a memory for storing executable instructions, wherein the one or more processors are configured to call the executable instructions stored in the memory to implement the above method.

In an aspect of the present disclosure, there is provided a computer-readable storage medium having computer program instructions stored thereon. The computer program instructions, when executed by a processor, implement the above method.

In an aspect of the present disclosure, there is provided a computer program product, comprising computer-readable codes or a nonvolatile computer-readable storage medium carrying computer-readable codes, wherein when the computer-readable codes are executed in an electronic apparatus, a processor in the electronic apparatus implements the above method.

In the embodiments of the present disclosure, in response to the element selection operation applied to the UI, the identification information of the target element corresponding to the element selection operation is determined based on the operation position of the element selection operation on the UI and the correspondence between the position on the UI and the identification information of the element, the layout file corresponding to the target element is acquired based on the identification information of the target element, and the layout file corresponding to the target element is displayed; and thus, the target element can be automatically determined based on the operation position of the element selection operation of the user in the UI without manually comparing the coordinates to determine the target element by the user, and the layout files corresponding to the elements in the UI can be rapidly acquired and displayed, so that the developer of the UI can rapidly view the layout file corresponding to the target element in the process of viewing the UI by selecting the target element in the UI. Therefore, the problems of high operation complexity and long time consumption of searching for the layout files corresponding to the elements in the UI in the related art can be solved, and the efficiency of developing the UI by the developer of the UI can be improved.

It should be understood that the general description above and the detailed description below are merely exemplary and explanatory, but not intended to limit the present disclosure.

Other features and aspects of the present disclosure will become apparent from the following detailed description of exemplary embodiments with reference to the accompanying drawings.

### BRIEF DESCRIPTION OF THE DRAWINGS

The drawings herein are incorporated into the specification and constitute a part of the specification, and these drawings show embodiments in conformity with the present disclosure and are used for illustrating the technical solution of the present disclosure together with the specification.

FIG. 1 shows a flow chart of an information display method of an interface element, as provided by an embodiment of the present disclosure.

FIG. 2 shows a schematic diagram of a UI of a short video Application (App).

FIG. 3 shows a schematic diagram of an information display method of an interface element, as provided by an embodiment of the present disclosure.

FIG. 4 shows a block diagram of an information display device of an interface element, as provided by an embodiment of the present disclosure.

FIG. 5 shows a block diagram of an electronic apparatus 800 provided by an embodiment of the present disclosure.

### DETAILED DESCRIPTION OF THE EMBODIMENTS

Various exemplary embodiments, features and aspects of the present disclosure will be illustrated in detail below with reference to the accompanying drawings. The same reference numerals in the drawings refer to elements with same or similar functions. Although various aspects of the embodiments are illustrated in the drawings, the drawings are not necessarily drawn to scale unless otherwise specified.

The term “exemplary” herein means “using as an example and an embodiment or being illustrative”. Any embodiment described herein as “exemplary” should not be construed as being superior to or better than other embodiments.

The term “and/or” used herein is only for describing an association relationship between the associated objects, which means that there may be three relationships, for example, A and/or B may denote three situations: A exists alone, both A and B exist, and B exists alone. Furthermore, the term “at least one of” herein means any one of a plurality of items or any combination of at least two of a plurality of items, for example, “including at least one of A, B and C” may imply including any one element or more elements selected from a set consisting of A, B and C.

Furthermore, for a better explanation of the present disclosure, numerous specific details are given in the following detailed description of the embodiments. Those skilled in the art should understand that the present disclosure may also be implemented without certain specific details. In some embodiments, methods, means, elements and circuits that are well known to those skilled in the art are not described in detail in order to highlight the main idea of the present disclosure.

The Fragment technology can split a UI of Android into several reusable components which are completely independently packaged, and each component has its own life cycle and UI layout. The UI is split into a plurality of fragments by using the Fragment technology, so that the layout of the UI can be simpler. In addition, a Model-View-Presenter (MVP) architecture enables the UI to be clearer in code logic when the layout is fragmented. Therefore, the Fragment and MVP architecture has become one of the popular App architectures.

Although the Fragment and MVP architecture enables the layout of the UI to be more loosened and enables the code logic to be clearer, there are still many inconveniences for a developer of the UI in the process of developing the UI and modifying the UI. With respect to a relatively complex interface structure, if the developer wants to view a layout file corresponding to a certain element (e.g., a certain button or a certain copywriting) in the UI, he or she needs to first find a fragment to which the element belongs, and then find the layout file corresponding to the element through the fragment, resulting in relatively high implementation complexity and long time consumption. With the increase of complexity of the UI, time consumed for positioning the fragment and searching for the layout file is also increased.

In the related art, the layout file corresponding to a certain element in the UI is generally acquired in the following two modes:

Mode I: the layout file corresponding to a certain element in the UI is acquired in an Android Debug Bridge (ADB) command line mode. In such a mode, information of the UI, which is currently displayed, is displayed in a text form through a command of “adb shell dumpsys activity|grep top”. The developer manually compares coordinates to determine a target element from the displayed information of the UI so as to acquire a layout file corresponding to the target element. However, if the UI is relatively complex, many relatively complex texts will be generated, and the developer needs to manually search for the target element from the numerous and complex texts, which is time-consuming.

Mode II: the layout file corresponding to a certain element in the UI is acquired through a layout Inspector provided by the Android Studio IDE. In such a mode, the currently displayed UI is displayed in a visual tree structure, and then the developer manually searches for the target element from the tree structure so as to acquire the layout file corresponding to the target element. With respect to the relatively complex UI, the developer needs to spend a long time in positioning the target element and searching for the layout file corresponding to the target element.

As is clear from the above, in the related art, the layout file corresponding to the element in the UI cannot be rapidly displayed, resulting in relatively low efficiency of developing the UI by the developer of the UI.

Embodiments of the present disclosure provide a method and a device of information display of an interface element, an apparatus, a medium, and a program product. In response to an element selection operation applied to a UI, identification information of a target element corresponding to the element selection operation is determined based on an operation position of the element selection operation on the UI and a correspondence between the position on the UI and identification information of the element, a layout file corresponding to the target element is acquired based on the identification information of the target element, and the layout file corresponding to the target element is displayed, and thus, the target element can be automatically determined based on the operation position of the element selection operation of a user in the UI without manually comparing coordinates to determine the target element by the user, and the layout files corresponding to the elements in the UI can be rapidly acquired and displayed, so that the developer of the UI can rapidly view the layout file corresponding to the target element in the process of viewing the UI by selecting the target element in the UI. Therefore, the problems of high operation complexity and long time consumption of searching for the layout files corresponding to the elements in the UI in the related art can be solved, and the efficiency of developing the UI by the developer of the UI can be improved.

The information display method of the interface element, as provided by the embodiment of the present disclosure, will be described in detail below with reference to the drawings.

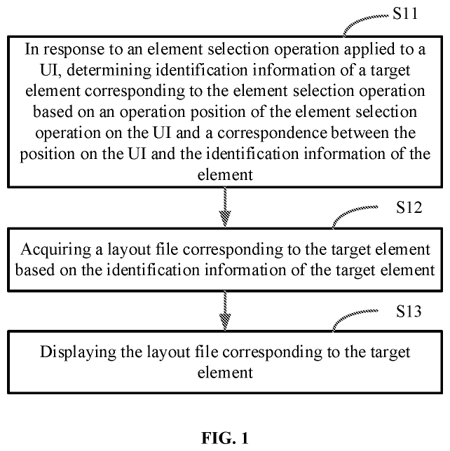

FIG. 1 shows a flow chart of an information display method of an interface element, as provided by an embodiment of the present disclosure. In a possible implementation, the information display method of the interface element may be executed by a terminal device or other electronic devices, wherein the terminal device may be User Equipment (UE), a mobile device, a user terminal, a terminal, a cellular phone, a cordless telephone, a Personal Digital Assistant (PDA), a handheld device, a computing device, a vehicle-mounted device or a wearable device and the like. In some possible implementations, the information display method of the interface element may be implemented by a processor calling a computer-readable instruction stored in a memory. As shown in FIG. 1, the information display method of the interface element includes steps S11 to S13.

In the step S11, in response to an element selection operation applied to a UI, determining identification information of a target element corresponding to the element selection operation based on an operation position of the element selection operation on the UI and a correspondence between the position on the UI and identification information of the element.

In the step S12, acquiring a layout file corresponding to the target element based on the identification information of the target element.

In the step S13, displaying the layout file corresponding to the target element.

In the embodiments of the present disclosure, the UI may represent a medium for carrying out interaction and information exchange between the terminal device and the user. The UI may implement transformation between an internal form of information and a user acceptable form. The UI in the embodiments of the present disclosure may be a UI of an App, a UI of an operating system, a UI of a webpage, and the like, which is not limited herein, wherein a UI of an App may be a random UI of the App, and for example, may be a random UI displayed in a case that the App is operated on the foreground. The App may be an App of a mobile phone terminal, or may be an App of a Personal Computer (PC) terminal, and the like, which is not limited herein, wherein an operating system of a mobile phone terminal may be an Android operating system, or may be an iOS operating system, a Windows operating system, and the like.

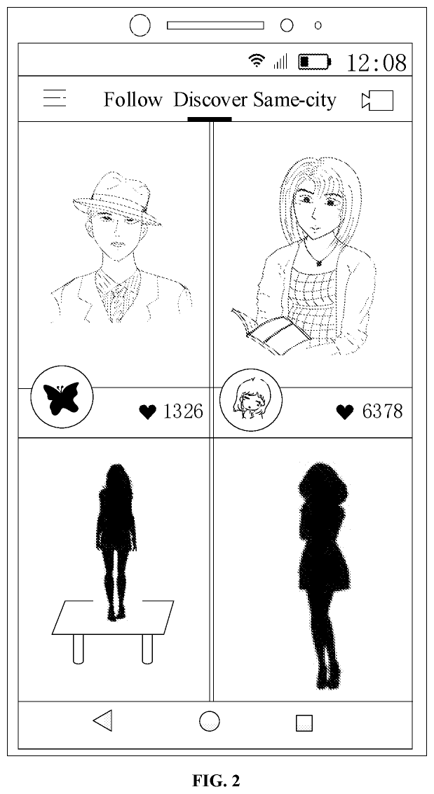

Any UI may include at least one element. Generally, one UI may include a plurality of elements. FIG. 2 shows a schematic diagram of a UI of a short video App. In an example shown in FIG. 2, the UI includes elements such as a “discover” control, a “same-city” control, a “follow” control, and a “like” control.

The element selection operation may represent an operation for selecting the elements. The element selection operation may be a single click operation, a double click operation, a long press operation, and the like, and can be determined based on actual demands, and the embodiments of the present disclosure do not make any specific limit thereto. By taking a case that the element selection operation is a single click operation as an example, the user (e.g., the developer of the UI) can make a single click on an element, a layout file of which is desired to be viewed by the user, by a mouse, a finger, a touch pad, a stylus, and the like in the UI so as to carry out the element selection operation.

After the terminal device detects the element selection operation applied to the UI, an operation position of the element selection operation on the UI can be acquired. In a possible implementation, the operation position of the element selection operation on the UI may be represented by coordinates. For example, the operation position of the element selection operation on the UI can be marked as (X₁, Y₁). In a possible implementation, the positions of the elements in the UI may be represented by coordinates. For example, the coordinates of any element can be marked as (X₂, Y₂).

In the embodiments of the present disclosure, in response to a case that a distance between the operation position of the element selection operation on the UI and the position of any element is smaller than or equal to a preset distance threshold, the element is determined as the target element, wherein the preset distance threshold is greater than or equal to 0, and the present distance threshold can be set based on specific demands, and the embodiments of the present disclosure do not make any specific limit thereto. For example, the distance d between the operation position of the element selection operation on the UI and the position of any element can be determined by Formula 1:

d=\sqrt{(X₁−X₂)²+(Y₁−Y₂)²} Formula 1

The operation position of the element selection operation on the UI is compared with the position of each element in the UI, and then the target element can be determined from each element of the UI. In the embodiments of the present disclosure, the target element can represent an element selected by the user in the currently displayed UI. There may be zero, one or two or more target elements. For example, in a case that the distance between the operation position of the element selection operation on the UI and the position of each element in the UI is greater than the preset distance threshold, the number of the target element is 0. In a case that the distance between the operation position of the element selection operation on the UI and the position of one element in the UI is smaller than or equal to the preset distance threshold, the number of the target element is 1. In a case that the distances between the operation position of the element selection operation on the UI and the positions of two or more elements in the UI are smaller than or equal to the preset distance threshold, the number of the target elements is 2 or more. In a case that the number of the target elements is 2 or more, the two or more target elements may overlap, or the two or more target elements do not overlap, but are all close to the operation position of the element selection operation.

In the embodiments of the present disclosure, the identification information of the element may be random information which can be used for uniquely identifying the element. For example, the identification information of the element may be the name, the serial number, and the like of the element. Correspondingly, the identification information of the target element may be random information which can be used for uniquely identifying the target element. For example, the identification information of the target element may be the name, the serial number, and the like of the target element.

The layout file corresponding to any element may represent a file used for laying out the element in the UI to which the element belongs. The layout file may be in an Extensible Markup Language (XML) format or other formats. The layout file corresponding to any element may only include layout information of the element, or may include layout information of other elements. Therefore, the element and the layout file may be in a one-to-one or many-to-one relationship. In a case that the layout file includes the layout information of a plurality of elements, the layout files corresponding to the plurality of elements may be the same layout file.

After the terminal device acquires the layout file corresponding to the target element, the layout file corresponding to the target element is displayed. In a possible implementation, the layout file corresponding to the target element may be displayed through a floating window. In another possible implementation, the currently displayed UI can be jumped to a layout file display interface so as to display the layout file corresponding to the target element through the layout file display interface, wherein the layout file display interface may represent a UI for displaying the layout file corresponding to the element. In an example, the layout file display interface may include a return control, and the return control may be used for returning to the previous UI (i.e., the UI to which the target element belongs).

In a possible implementation, acquiring the layout file corresponding to the target element according to the identification information of the target element comprises: acquiring tag information of the target element based on the identification information of the target element; and acquiring the layout file corresponding to the target element from the tag information of the target element, wherein the tag information also may be called as Tag information. The tag information of any element may include a key and a value, wherein the key may represent the name of the layout file corresponding to the element, and the value may be the layout file corresponding to the element. The tag information of the target element can be acquired based on the identification information of the target element. The layout file corresponding to the target element can be obtained by reading the tag information of the target element. In this implementation, the tag information of the target element is acquired based on the identification information of the target element and the layout file corresponding to the target element is acquired from the tag information of the target element, thereby improving convenience of acquiring the layout file corresponding to the target element.

In yet another possible implementation, a correspondence between the identification information of the element and the identification information of the layout file can be pre-established, so that the layout file corresponding to the target element can be acquired based on the identification information of the target element and the correspondence between the identification information of the element and the identification information of the layout file, wherein the identification information of the layout file may represent information which can be used for uniquely identifying the layout file. For example, the identification information of the layout file may be the name, the serial number, and the like of the layout file.

In a possible implementation, before the identification information of the target element corresponding to the element selection operation is determined in response to the element selection operation applied to the UI based on the operation position of the element selection operation on the UI and the correspondence between the position on the UI and the identification information of the element, the method further comprises: in response to an activation of the UI, acquiring structural information of the UI; and parsing the structural information to obtain the correspondence between the position on the UI and the identification information of the element. In this implementation, a monitoring event can be registered so as to monitor an activation of the UI. The activation of the UI in this implementation may be first activation of the UI, or may be non-first activation. For example, an activation of a UI 1 may be the first activation of the UI 1, or may be that after being activated, the UI 1 is switched to a UI 2, and then the UI 2 is switched back to the UI 1.

In this implementation, the UI may be of a tree structure, or may be of a structure in other forms, which is not limited herein. In an example, in a case that the information display method of the interface element is applied to the Android operating system, in response to activation of the UI, a Hook function can be called to acquire the UI. The main thread of Android, ActivityThread, is unique, so the tree structure of the currently displayed UI can be acquired through Hook ActivityThread.

In an example, the UI is of a tree structure, and the elements in the UI correspond to nodes in the tree structure corresponding to the UI one to one. The nodes in the tree structure of the UI can be respectively parsed into view objects by traversing the tree structure of the UI. As the elements in the UI correspond to the nodes in the tree structure corresponding to the UI one to one, the view objects obtained by parsing also correspond to the elements one to one, wherein attribute information of any one view object may include the identification information and the position of the corresponding element.

In this implementation, an element set of the UI can be generated based on the correspondence between the position on the UI and the identification information of the element, and the attribute information of any element in the element set may include the identification information and the position of the element. In an example, the attribute information of the element may further include tag information of the element. Certainly, in some examples, the attribute information of the element may further include other information for representing characteristics of the element.

In this implementation, the structural information of the UI is acquired in response to an activation of the UI, and the structure information is parsed to obtain the correspondence between the position on the UI and the identification information of the element, and thus, after the element selection operation applied to the UI is detected, the target element can be automatically, accurately, and rapidly determined based on the operation position of the element selection operation on the UI and the corresponding relationship.

In another possible implementation, the method further comprises: in response to an interface structure parsing request, acquiring the structural information of the UI; and parsing the structural information to obtain the correspondence between the position on the UI and the identification information of the element. In this implementation, the structure of the UI can be parsed in response to the request of the user.

In a possible implementation, before acquiring the layout file corresponding to the target element based on the identification information of the target element, the method further comprises: in response to an activation of the UI, acquiring the layout file corresponding to the UI; and parsing the layout file corresponding to the UI to obtain the layout file corresponding to the element in the UI. In this implementation, the layout file corresponding to the UI may be parsed by LayoutInflater in the UI layout process. Certainly, the layout file corresponding to the UI may also be parsed in other modes, which is not limited herein. In this implementation, the layout file corresponding to the UI is acquired in response to and activation of the UI, and the layout file corresponding to the UI is parsed to obtain the layout files corresponding to the elements in the UI are obtained, and thus, the layout file corresponding to each element in the UI can be timely obtained, so that after the element selection operation applied to the UI is detected, the layout files of the corresponding elements can be timely displayed for the user, and fluency of displaying the layout files corresponding to the elements is improved.

As an example of this implementation, after obtaining the layout file corresponding to the element in the UI, the method further comprises: for any element of the UI, setting the tag information of the element, and storing the layout file corresponding to the element through the tag information of the element. In this example, the tag information of the element is used for storing the layout file corresponding to the element. The tag information can be respectively set for each element in the UI so as to store the corresponding layout file. In this example, by setting the tag information of the element and storing the layout file corresponding to the element through the tag information of the element, the layout file corresponding to the element can be rapidly acquired from the tag information of the element when the layout file corresponding to the element needs to be displayed.

In another possible implementation, the method further comprises: in response to a layout file parsing request, acquiring the layout file corresponding to the UI; and parsing the layout file corresponding to the UI to obtain the layout file corresponding to the element in the UI. In this implementation, the layout file corresponding to the UI can be parsed in response to the request of the user.

In a possible implementation, acquiring the layout file corresponding to the target element based on the identification information of the target element comprises: in a case that the operation position corresponds to two or more target elements, acquiring the layout files corresponding to the two or more target elements based on the identification information of the two or more target elements; and displaying the layout files corresponding to the target elements comprises: displaying the layout files corresponding to the two or more target elements based on hierarchy information and/or position information of the two or more target elements.

In this implementation, in a case that the operation position corresponds to two or more target elements, the layout files corresponding to the two or more target elements can be respectively acquired based on the identification information of the two or more target elements.

As an example of this implementation, the layout files corresponding to the two or more target elements can be respectively displayed through the floating windows corresponding to the two or more target elements one to one. As another example of this implementation, the layout files corresponding to the two or more target elements can be displayed through the same floating window. For example, the layout files corresponding to the two or more target elements can be displayed through different containers in the same floating window.

As an example of this implementation, the layout files corresponding to the two or more target elements can be displayed based on the hierarchy information of the two or more target elements. As another example of this implementation, the layout files corresponding to the two or more target elements can be displayed based on the position information of the two or more target elements. As yet another example of this implementation, the layout files corresponding to the two or more target elements can be displayed based on the hierarchy information and the position information of the two or more target elements.

In an example, the layout files corresponding to the two or more target elements can be respectively displayed through the floating windows corresponding to the two or more target elements one to one. For a first target element and a second target element in the two or more target elements, if the first target element is positioned above the second target element, a first floating window corresponding to the first target element is displayed above a second floating window corresponding to the second target element, wherein the first floating window partially covers the second floating window. If the first target element and the second target element are positioned on the same layer of the UI, the first floating window and the second floating window can be displayed based on the position information of the first target element and the second target element. For example, if the first target element is positioned on the left side of the second target element, the first floating window is displayed on the left side of the second floating window.

In this implementation, in a case that the operation position corresponds to two or more target elements, the layout files corresponding to the two or more target elements are acquired based on the identification information of the two or more target elements, and the layout files corresponding to the two or more target elements are displayed based on the hierarchy information and/or the position information of the two or more target elements. Therefore, in a case that the elements in the UI overlap or are close to each other, the layout files corresponding to the target elements can also be orderly displayed, which is conducive to reducing the probability of the developer mis-reading or mis-correcting the layout files by mistake.

In a possible implementation, after displaying the layout file corresponding to the target element, the method further comprises: in response to a modification instruction for the layout file corresponding to the target element, modifying the layout file corresponding to the target element. As an example of this implementation, the developer of the UI may modify the layout file corresponding to the target element in the floating window. In this implementation, the layout file corresponding to the target element can be rapidly acquired and displayed, and the user is allowed to modify the displayed layout file, so the time of modifying the layout information of the element by the developer of the UI can be shortened, and accordingly the speed of modifying the element in the UI can be improved and the research and development efficiency can be improved.

As an example of this implementation, in a case of storing the layout file corresponding to the target element through the tag information of the target element, after the layout file corresponding to the target element is modified, the tag information of the target element is updated.

In a possible implementation, codes corresponding to the information display method of the interface element, which is provided by the embodiments of the present disclosure, can be packaged and uploaded to a Maven repository, and corresponding dependence is generated. If the developer wants to use the information display method of the interface element, which is provided by the embodiments of the present disclosure, the dependence can be introduced into a target App from the Maven repository and operated, so that the function of rapidly displaying the layout files corresponding to the elements in the UI can be achieved. This implementation provides a plug-in capable of rapidly displaying the layout files corresponding to the elements in the UI, so that the developer of the UI does not need to search for the layout files corresponding to the elements from a text through ADB each time.

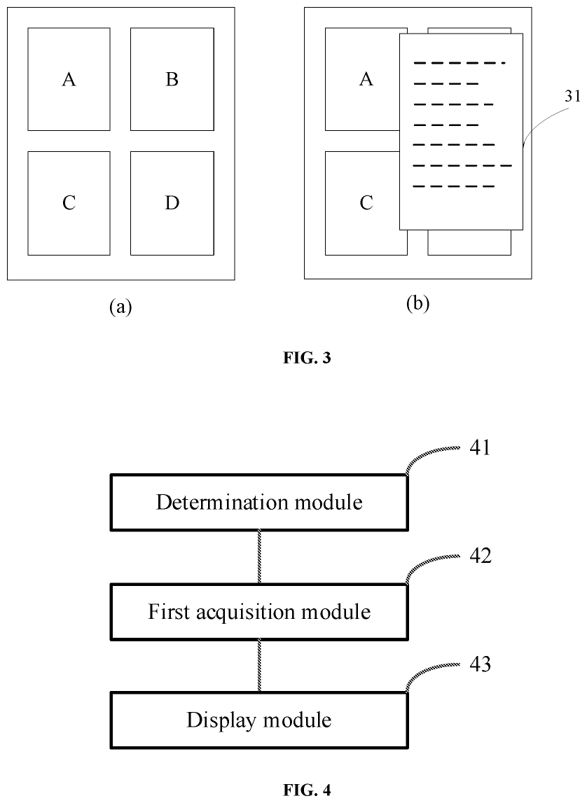

The information display method of the interface element, which is provided by the embodiments of the present disclosure, will be illustrated below through a specific application scenario. FIG. 3 shows a schematic diagram of an information display method of an interface element, as provided by an embodiment of the present disclosure. As shown in FIG. 3(a), a currently displayed UI includes an element A, an element B, an element C, and an element D. As shown in FIG. 3(b), in response to a click on the element A, a layout file corresponding to the element A can be displayed through a floating window 31. In this application scenario, the developer of the UI can rapidly view a layout file corresponding to a target element by clicking on the target element in the currently displayed UI in the process of viewing the UI.

It should be understood that all the method embodiments mentioned in the present disclosure, without departing from the principle logic, can be combined with each other to form combined embodiments, which will not be repeated in the present disclosure due to the limited space. Those skilled in the art could understand that in the above-mentioned methods of the specific embodiments, the specific executing sequence of each step should be determined based on the function and the possible internal logic thereof.

In addition, the present disclosure further provides an information display device of an interface element, an electronic apparatus, a computer-readable storage medium, and a program, all of which can be used for implementing any one information display method of the interface element provided by the present disclosure. For the corresponding technical solutions and technical effects, reference may be made to the corresponding description in the method section, which will not be repeated.

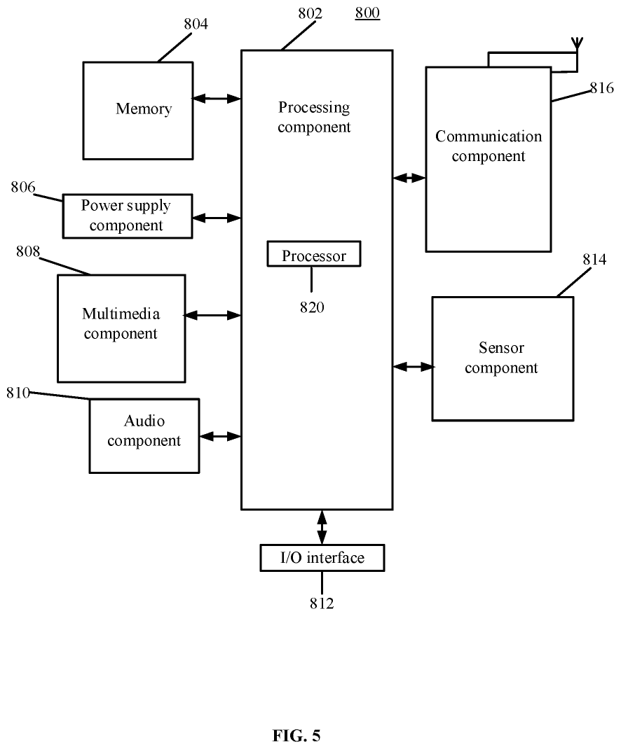

FIG. 4 shows a block diagram of an information display device of an interface element, as provided by an embodiment of the present disclosure. As shown in FIG. 4, the information display device of the interface element comprises: a determination module 41 for, in response to an element selection operation applied to a UI, determining identification information of a target element corresponding to the element selection operation based on an operation position of the element selection operation on the UI and a correspondence between the position on the UI and identification information of element; a first acquisition module 42 for acquiring a layout file corresponding to the target element based on the identification information of the target element; and a display module 43 for displaying the layout file corresponding to the target element.

In a possible implementation, the first acquisition module 42 is configured to: acquire tag information of the target element based on the identification information of the target element; and acquire the layout file corresponding to the target element from the tag information of the target element.

In a possible implementation, the device further comprises: a second acquisition module to acquire, in response to an activation of the UI, structural information of the UI; and a first parsing module to parse the structural information to obtain a correspondence between the position on the UI and the identification information of the element.

In a possible implementation, the device further comprises: a second parsing module to acquire, in response to an activation of the UI, a layout file corresponding to the UI; and a third acquisition module to parse the layout file corresponding to the UI to obtain the layout file corresponding to the element in the UI.

In a possible implementation, the device further comprises: a setting module to set, for any one element of the UI, the tag information of the element, and storing the layout file corresponding to the element through the tag information of the element.

In a possible implementation, the first acquisition module 42 is configured to acquire, in a case that the operation position corresponds to two or more target elements, the layout files corresponding to the two or more target elements based on the identification information of the two or more target elements; and the display module 43 is configured to display the layout files corresponding to the two or more target elements based on hierarchy information and/or position information of the two or more target elements.

In a possible implementation, the device further comprises: a modification module to modify the layout file corresponding to the target element, in response to a modification instruction for the layout file corresponding to the target element.

In the embodiments of the present disclosure, in response to the element selection operation applied to the UI, the identification information of the target element corresponding to the element selection operation is determined based on the operation position of the element selection operation on the UI and the correspondence between the position on the UI and the identification information of the element, the layout file corresponding to the target element is acquired based on the identification information of the target element, and the layout file corresponding to the target element is displayed. Therefore, the target element can be automatically determined based on the operation position of the element selection operation of the user in the UI without manually comparing the coordinates to determine the target element by the user, and the layout files corresponding to the elements in the UI can be rapidly acquired and displayed, so the developer of the UI can rapidly view the layout file corresponding to the target element in the process of viewing the UI by selecting the target element in the UI. Therefore, the problems of high operation complexity and long time consumption of searching for the layout files corresponding to the elements in the UI in the related art can be solved, and the efficiency of developing the UI by the developer of the UI can be improved.

In some embodiments, the functions of the device or the modules comprised by the device provided by the embodiments of the present disclosure can be used for executing the method described in the method embodiments above, and for the specific implementation and technical effects, reference may be made to the description of the method embodiments above, which will not be repeated herein for brevity.

An embodiment of the present disclosure further provides a computer-readable storage medium, having computer program instructions stored thereon. The computer program instructions, when executed by a processor, implement the above-mentioned method, wherein the computer-readable storage medium may be a nonvolatile computer-readable storage medium, or may be a volatile computer-readable storage medium.

An embodiment of the present disclosure further provides a computer program, including computer-readable codes. When the computer-readable codes run in an electronic apparatus, a processor in the electronic apparatus executes the above-mentioned method.

An embodiment of the present disclosure further provides a computer program product, comprising computer-readable codes or a nonvolatile computer-readable storage medium carrying the computer-readable codes. When the computer-readable codes run in an electronic apparatus, a processor in the electronic apparatus executes the above-mentioned method.

An embodiment of the present disclosure further provides an electronic apparatus, comprising: one or more processors; a memory for storing executable instructions, wherein the one or more processors are configured to call the executable instructions stored in the memory so as to execute the above-mentioned method.

The electronic apparatus may be provided as a terminal, a server, or apparatuses in other forms.

FIG. 5 shows a block diagram of an electronic apparatus 800 provided by an embodiment of the present disclosure. For example, the electronic apparatus 800 may be a mobile phone, a computer, a digital broadcast terminal, a message transceiver, a game console, a tablet device, medical equipment, fitness equipment, a PDA, or any other terminal.

Referring to FIG. 5, the electronic apparatus 800 may comprise one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the electronic apparatus 800, such as operations related to display, phone call, data communication, camera operation, and record operation. The processing component 802 may comprise one or more processors 820 to execute instructions so as to complete all or some steps of the above method. Furthermore, the processing component 802 may comprise one or more modules for facilitating interaction between the processing component 802 and other components. For example, the processing component 802 may comprise a multimedia module to facilitate the interaction between the multimedia component 808 and the processing component 802.

The memory 804 is configured to store various types of data to support the operations of the electronic apparatus 800. Examples of these data include instructions for any application or method operated on the electronic apparatus 800, contact data, telephone directory data, messages, pictures, videos, etc. The memory 804 may be implemented by any type of volatile or non-volatile storage apparatuses or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or a compact disk.

The power supply component 806 supplies electric power to various components of the electronic apparatus 800. The power supply component 806 may comprise a power supply management system, one or more power supplies, and other components related to the generation, management, and allocation of power for the electronic apparatus 800.

The multimedia component 808 comprises a screen providing an output interface between the electronic apparatus 800 and a user. In some embodiments, the screen may comprise a Liquid Crystal Display (LCD) and a Touch Panel (TP). If the screen comprises the touch panel, the screen may be implemented as a touch screen to receive an input signal from the user. The touch panel comprises one or more touch sensors to sense the touch, sliding and gestures on the touch panel. The touch sensor may not only sense a boundary of the touch or sliding operation, but also detect the duration and pressure related to the touch or sliding operation. In some embodiments, the multimedia component 808 comprises a front camera and/or a rear camera. When the electronic apparatus 800 is in an operating mode such as a shooting mode or a video mode, the front camera and/or the rear camera may receive external multimedia data. Each front camera and rear camera may be a fixed optical lens system or have a focal length and optical zooming capacity.

The audio component 810 is configured to output and/or input an audio signal. For example, the audio component 810 comprises a microphone (MIC). When the electronic apparatus 800 is in the operating mode such as a call mode, a record mode and a voice identifying mode, the microphone is configured to receive an external audio signal. The received audio signal may be further stored in the memory 804 or sent by the communication component 816. In some embodiments, the audio component 810 also comprises a loudspeaker which is configured to output the audio signal.

The I/O interface 812 provides an interface between the processing component 802 and a peripheral interface module. The peripheral interface module may be a keyboard, a click wheel, buttons, etc. These buttons may include, but are not limited to: a home button, a volume button, a start button, and a lock button.

The sensor component 814 comprises one or more sensors which are configured to provide state evaluation in various aspects for the electronic apparatus 800. For example, the sensor component 814 may detect an on/off state of the electronic apparatus 800 and relative positions of the components such as a display and a keypad of the electronic apparatus 800. The sensor component 814 may also detect the position change of the electronic apparatus 800 or a component of the electronic apparatus 800, presence or absence of a user contact with the electronic apparatus 800, directions or acceleration/deceleration of the electronic apparatus 800 and the temperature change of the electronic apparatus 800. The sensor component 814 may include a proximity sensor configured to detect the presence of nearby objects without physical contact. The sensor component 814 may further comprise an optical sensor, such as a Complementary Metal Oxide Semiconductor (CMOS) or Charge Coupled Device (CCD) image sensor, for use in the imaging application. In some embodiments, the sensor component 814 may further comprise an acceleration sensor, a gyroscope sensor, a magnetic sensor, a pressure sensor or a temperature sensor.

The communication component 816 is configured to facilitate the communication in a wired or wireless mode between the electronic apparatus 800 and other apparatuses. The electronic apparatus 800 may access a wireless network based on communication standards, such as wireless fidelity (Wi-Fi), a 2^{nd} generation mobile communication technology (2G), a 3^{rd} generation mobile communication technology (3G), a 4^{th} generation mobile communication technology (4G), Long Term Evolution (LTE) of the mobile communication technology, a 5^{th} generation mobile communication technology (5G), or a combination thereof. In an exemplary embodiment, the communication component 816 receives a broadcast signal or broadcast related information from an external broadcast management system via a broadcast channel. In an exemplary embodiment, the communication component 816 further comprises a Near Field Communication (NFC) module to promote the short range communication. For example, the NFC module may be implemented on the basis of a Radio Frequency Identification (RFID) technology, an Infrared Data Association (IrDA) technology, an Ultra Wide Band (UWB) technology, a Bluetooth (BT) technology and other technologies.

In an exemplary embodiment, the electronic apparatus 800 can be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components, and is used to execute the above method.

In an exemplary embodiment, there is further provided a non-volatile computer-readable memory medium, such as the memory 804 including computer program instructions. The computer program instructions may be executed by the processor 820 of the electronic apparatus 800 to implement the above method.

The present disclosure may be implemented by a system, a method, and/or a computer program product. The computer program product may comprise a computer-readable storage medium having computer-readable program instructions for causing a processor to carry out the aspects of the present disclosure stored thereon.

The computer-readable storage medium can be a tangible device that can hold and store instructions used by an instruction functioning as a device. The computer-readable storage medium may be, but is not limited to, e.g., electronic storage device, magnetic storage device, optical storage device, electromagnetic storage device, semiconductor storage device, or any proper combination thereof. More specific examples (a non-exhaustive list) of the computer-readable storage medium include: a portable computer disk, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. The computer-readable storage medium used herein should not be construed as transitory signal per se, such as radio waves or other electromagnetic waves which propagate freely, electromagnetic waves propagating through a waveguide or other transmission media (e.g., light pulses propagating through a fiber-optic cable), or electrical signals transmitted through a wire.

Computer-readable program instructions described herein can be downloaded to individual computing/processing devices from a computer-readable storage medium or to an external computer or external storage device via a network, for example, the Internet, local area network, wide area network and/or wireless network. The network may comprise copper transmission cables, optical fiber transmission, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium in the respective computing/processing devices.

Computer-readable program instructions for carrying out the operations of the present disclosure may be assembly instructions, instruction-set-architecture (ISA) instructions, machine instructions, machine-related instructions, microcode, firmware instructions, state-setting data, or source code or object code written in any combination of one or more programming languages. The programming languages include object-oriented programming languages, such as Smalltalk, C++ or the like, and the conventional procedural programming languages, such as the “C” programming language or similar programming languages. The computer-readable program instructions may be executed entirely on a user's computer, partly on a user's computer, as a stand-alone software package, partly on a user's computer and partly on a remote computer, or entirely on a remote computer or a server. In a scenario involving a remote computer, the remote computer may be connected to the user's computer through any type of network, including local area network (LAN) or wide area network (WAN), or connected to an external computer (for example, using an Internet Service Provider to connect through the Internet). In some embodiments, electronic circuitry, such as programmable logic circuitry, field-programmable gate arrays (FPGA), or programmable logic arrays (PLA), may be customized by using state information of the computer-readable program instructions; and the electronic circuitry may execute the computer-readable program instructions, so as to achieve various aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer-readable program instructions.

These computer-readable program instructions may be provided to a processor of a general purpose computer, a dedicated computer, or other programmable data processing devices, to form a machine, such that when the instructions are executed by the processor of the computer or other programmable data processing devices, the machine implements the functions/actions specified in one or more blocks in the flowchart and/or block diagram. These computer-readable program instructions may also be stored in a computer-readable storage medium, and the instructions cause the computer, programmable data processing device and/or other devices to function in a particular manner, such that the computer-readable storage medium having instructions stored thereon comprises a product that includes instructions implementing aspects of the functions/actions specified in one or more blocks in the flowchart and/or block diagram.

The computer-readable program instructions may also be loaded into a computer, other programmable data processing devices, or other devices to cause a series of operational operations to be executed on the computer, other programmable devices or other devices, so as to produce a computer implemented process, such that the instructions executed on the computer, other programmable devices or other devices implement the functions/actions specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a module, a program segment, or a part of an instruction, and the module, program segment, or part of an instruction comprises one or more executable instructions for implementing the specified logical function(s). In some alternative implementations, the functions denoted in the blocks may occur in an order different from that denoted in the drawings. For example, two consecutive blocks may, in fact, be executed substantially in parallel, or sometimes they may be executed in a reverse order, depending upon the functions involved. It should also be noted that each block in the block diagram and/or flowchart, and combinations of blocks in the block diagram and/or flowchart, can be implemented by dedicated hardware-based systems performing the specified functions or actions, or by combinations of dedicated hardware and computer instructions.

The computer program product can be implemented by hardware, software, or a combination thereof. In one optional embodiment, the computer program product is specifically implemented as a computer storage medium, and in another optional embodiment, the computer program product is specifically implemented as a software product, such as a Software Development Kit (SDK).

Although the embodiments of the present disclosure have been described above, it will be appreciated that the above descriptions are merely exemplary but not exhaustive, and that the disclosed embodiments are not limiting. A number of variations and modifications, without departing from the scopes and spirits of the described embodiments, are apparent to one skilled in the art. The terms selected in the present disclosure are intend to best explain the principles of the embodiments, practical applications or the technical improvements to the arts in the market, or to make the embodiments described herein understandable to one skilled in the art.

1. A method for information display of interface elements, the method comprising:
in response to an element selection operation applied to a user interface, determining identification information of a target element corresponding to the element selection operation based on an operation position of the element selection operation on the user interface and a correspondence between the operation position on the user interface and the identification information of the target element;
acquiring a layout file corresponding to the target element based on the identification information of the target element; and
displaying the layout file corresponding to the target element.

2. The method according to claim 1, wherein acquiring the layout file corresponding to the target element based on the identification information of the target element comprises:
acquiring tag information of the target element based on the identification information of the target element; and
acquiring the layout file corresponding to the target element from the tag information of the target element.

3. The method according to claim 1, wherein before determining the identification information of the target element corresponding to the element selection operation, the method further comprises:
in response to an activation of the user interface, acquiring structural information of the user interface; and
parsing the structural information to obtain the correspondence between the operation position on the user interface and the identification information of the target element.

4. The method according to claim 1, wherein before acquiring the layout file corresponding to the target element based on the identification information of the target element, the method further comprises:
in response to an activation of the user interface, acquiring a layout file corresponding to the user interface; and
parsing the layout file corresponding to the user interface to obtain a layout file corresponding to the target element in the user interface.

5. The method according to claim 4, wherein after obtaining the layout file corresponding to the target element in the user interface, the method further comprises:
for a given element of the user interface, setting tag information of the given element, and storing the layout file corresponding to the given element through the tag information of the given element.

6. The method according to claim 1, wherein:
acquiring the layout file corresponding to the target element based on the identification information of the target element comprises: in response to the operation position corresponding to two or more target elements, acquiring the layout files corresponding to the two or more target elements based on the identification information of the two or more target elements; and
displaying the layout file corresponding to the target element comprises: displaying the layout files corresponding to the two or more target elements based on hierarchy information and/or position information of the two or more target elements.

7. The method according to claim 1, wherein after displaying the layout file corresponding to the target element, the method further comprises:
in response to a modification instruction for the layout file corresponding to the target element, modifying the layout file corresponding to the target element.

8. (canceled)

9. An electronic apparatus, comprising:
one or more processors; and
a memory storing instructions executable by the one or more processors,
wherein the instructions cause the one or more processors to:
in response to an element selection operation applied to a user interface, determine identification information of a target element corresponding to the element selection operation based on an operation position of the element selection operation on the user interface and a correspondence between the operation position on the user interface and the identification information of the target element;
acquire a layout file corresponding to the target element based on the identification information of the target element; and
display the layout file corresponding to the target element.

10.-11. (canceled)

12. The electronic apparatus according to claim 9, wherein the instructions further cause the one or more processors to:
acquire tag information of the target element based on the identification information of the target element; and
acquire the layout file corresponding to the target element from the tag information of the target element.

13. The electronic apparatus according to claim 9, wherein before determining the identification information of the target element corresponding to the element selection operation, the instructions further cause the one or more processors to:
in response to an activation of the user interface, acquire structural information of the user interface; and
parse the structural information to obtain the correspondence between the operation position on the user interface and the identification information of the target element.

14. The electronic apparatus according to claim 9, wherein before acquiring the layout file corresponding to the target element based on the identification information of the target element, the instructions further cause the one or more processors to:
in response to an activation of the user interface, acquire a layout file corresponding to the user interface; and
parse the layout file corresponding to the user interface to obtain a layout file corresponding to the target element in the user interface.

15. The electronic apparatus according to claim 14, wherein after obtaining the layout file corresponding to the target element in the user interface, the instructions further cause the one or more processors to:
for a given element of the user interface, set tag information of the given element, and store the layout file corresponding to the given element through the tag information of the given element.

16. The electronic apparatus according to claim 9, wherein the instructions further cause the one or more processors to:
in response to the operation position corresponding to two or more target elements, acquire the layout files corresponding to the two or more target elements based on the identification information of the two or more target elements; and
display the layout files corresponding to the two or more target elements based on hierarchy information and/or position information of the two or more target elements.

17. The electronic apparatus according to claim 9, wherein after displaying the layout file corresponding to the target element, the instructions further cause the one or more processors to:
in response to a modification instruction for the layout file corresponding to the target element, modify the layout file corresponding to the target element.

18. A non-transitory computer-readable storage medium having computer program instructions stored thereon, wherein the computer program instructions, when executed by one or more processors, cause the one or more processors to:
in response to an element selection operation applied to a user interface, determine identification information of a target element corresponding to the element selection operation based on an operation position of the element selection operation on the user interface and a correspondence between the operation position on the user interface and the identification information of the target element;
acquire a layout file corresponding to the target element based on the identification information of the target element; and
display the layout file corresponding to the target element.
